(19) United States
(12) Patent Application Publication
(10) Pub. No.: US 2014/0349736 A1
(43) Pub. Date: Nov. 27, 2014

(54) METHODS AND SYSTEMS OF GENERATING A PLAYER TO PLAYER SLOT MACHINE

(71) Applicant: Adam Jae Chun Lee, Honolulu, HI (US)

(72) Inventor: Adam Jae Chun Lee, Honolulu, HI (US)

(21) Appl. No.: 14/286,979

(22) Filed: May 23, 2014

Related U.S. Application Data
(60) Provisional application No. 61/827,431, filed on May 24, 2013.

(51) Int. Cl. G07F 17/34

(52) U.S. Cl. CPC G07F 17/34
USPC 463/20

(57) ABSTRACT

A system for generating a peer-to-peer (p2p) slot machine is provided. The system including a p2p engine, wherein the p2p engine is configured to create a slot machine for play between a first user acting as a banking player and a second user acting as a betting player. The system also includes an interface coupled to the p2p engine and configured to receive data from the banking player and the betting player. The system also includes a management engine coupled to the p2p engine, wherein the management engine is configured to audit the slot machine.

### CROSS-REFERENCE TO RELATED APPLICATIONS

This application claims priority to provisional application No. 61/827,431 filed May 24, 2014, and incorporates the contents of that application by reference in its entirety.

### BACKGROUND OF THE DISCLOSURE

Current slot machines are popular gambling devices where the slot machine is programmed to provide at least one gambling game, such as but not limited to, poker slot reels, roulette, baccarat, bingo, and/or any other gambling game, and a player places bets on the gambling game. Known slot machines are structured such that the player bets against the operator of the machine, or the house. To generate revenue, the house generally has a statistical advantage in the game such that over a large number of bets the machine returns only a percentage of the amount bet. The percentage of bets not returned to players is commonly referred to as “house edge,” “vig,” “cut,” “take,” and/or “juice.” Although the juice varies depending on the slot game, manufacturer, location, and/or operator, known slot machines typically operate with 1-20% juice. While this format is lucrative for the house, many players do not play slot games where the house has a substantial advantage over the player, or play for relatively low amounts for the entertainment value knowing the chances of winning are stacked against them.

As known slot and video gaming machines are designed with the odds stacked in favor of the house, players' entertainment and enjoyment of the slot machine is reduced, reducing the playing time at the slot machine and reducing revenue of the slot machine. Accordingly, it may be advantageous to provide a system that enables a first player to bank a slot machine and pay out the results of slot machine play played by a second player while the house monitors play.

The foregoing examples of the related art and limitations related therewith are intended to be illustrative and not exclusive. Other limitations of the related art will become apparent upon a reading of the specification and a study of the drawings.

### BRIEF DESCRIPTION OF THE DISCLOSURE

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

Herein, there is provided a system and method for providing a player-to-player slot machine platform that is able to create a machine for play by a first player that is banking the slot machine, hereinafter a “banking player,” and a second player placing bets on outcomes generated by the slot machine, hereinafter a “betting player.” The banking player occupies the position usually taken by the house and pays the betting player on winning outcomes associated with the slot machine and collects from the betting player during losing outcomes associated with the slot machine. The banking player chooses settings for the machine they are “banking” such as the theme of the machine, i.e., a setting from a famous movie, pirates, jungles, space, ancient Egypt, and/or any other theme desired by the banking player. The banking player may also set a maximum amount bet per spin, an amount of bankroll put into the machine, alerts to be sent to him when events associated with the slot machine occur, circumstances when the machine can be disabled, a rate of return for the machine, and other similar settings. The banking player may choose to bank multiple slot machines to create a p2p slot machine room that is player banked. The system enables banking players and the betting players to view play on the slot machines as they are being played in real-time, as a recorded history, and/or as clips of particular events.

Furthermore, in the system betting players play the slot machine as they would a regular slot machine operated by a standard house. In particular, betting players choose a slot machine to play, initialize play by capitalizing their play, i.e., from a pre-loaded card, player account, cash, credit card, or any other payment device. The betting player selects an amount to wager and begins play.

The system further includes a management system that determines sufficient capitalization of the slot machine by the banking player to pay winning outcomes, and enables the slot machine to be played by betting players. The management system may also determine if any events require suspension of the slot machine or alerts to be sent to the banking player. For example, if capitalization is reduced below an amount needed to pay for a possible outcome, the management system may suspend operation of the slot machine and send an alert to the banking player. The management system further reconciles accounts between the betting player and banking player during operation of the slot machine. After each outcome, or playing session, the management system credits the account of the player associated with the winning outcome and debits the account of the player associated with the losing outcome. In one embodiment, the management system may set aside a percentage of the amount bet between the betting player and the banking player as a service fee.

Such a system can be provided electronically via an interface to a computing system. The system can operate via a player-to-player (p2p) engine operating under the supervision of a management engine where the p2p engine provides various slot machine themes and games to users in a p2p environment via an interface.

Additionally or alternatively, such a system can be provided as a stand-alone device in the form of a typical casino slot machine networked and inter-operable with a web-based casino. The web-based casino may allow access to the network for on premise only gaming and/or on-premise and off-premise gaming.

By way of example, a betting player may play the slot machine that is being banked by a banking player and lose $10. The banking player has won the $10 dollars and the management system debits the $10 from the betting players account and transfer the $10 to the banking players account. Alternatively, the management system transfers a percentage of the $10, e.g., without limitation, $9.70, to the banking player and $0.30 to the operator of the management system. The management system may charge the service fee for handling the game whether the outcome is a win or a loss. Additionally, the service fee can be charged for overall activity.

The management system may provide numerous alerts and information to a banking player. For example, alerts may be sent when the banking player has won or lost a certain amount of money, when the betting player has hit a jackpot or other certain amount, when a certain amount of aggregate handle has been played, when any betting player deposits money into the machine, when a betting player leaves the machine, when a particular betting player deposits money into the slot machine, when a particular betting player has reached a set amount of time, handle, wins, losses, and/or other threshold, and other similar information.

In one embodiment, the p2p slot machine has a plurality of settings that enable the machine to be enabled, disabled, suspended, or otherwise altered based on triggers associated with play. Triggers include, without limitation, when the banking player wins or loses a certain amount of money, when the betting player has hit a jackpot or other certain amount, when the banking player's account reaches a set amount of money, when a certain amount of aggregate handle has been played, when any betting player deposits money into the machine, when a betting player leaves the machine, when a particular betting player deposits money into the slot machine, when a particular betting player has reached a set amount of time, handle, wins, losses, and/or other threshold, and other similar information, when a betting player deposits money, when a betting player redeposit money, when a betting player cashes out, when the overall time on the machine reaches a certain amount, when a particular betting player reaches a set amount of time on the machine, total wins, total losses, and other similar information.

In one embodiment, the management system generates data reports based on play on the slot machine. The data reports may contain results and payouts tracked during play and may be related to certain points in a video recording of play so that the banking player can see when certain triggering events occurred. The triggering events include, without limitation, when the banking player wins or loses a certain amount of money, when the betting player has hit a jackpot or other certain amount, when the banking player's account reaches a set amount of money, when a certain amount of aggregate handle has been played, when any betting player deposits money into the machine, when a betting player leaves the machine, when a particular betting player deposits money into the slot machine, when a particular betting player has reached a set amount of time, handle, wins, losses, and/or other threshold, and other similar information, when a betting player deposits money, when a betting player redeposit money, when a betting player cashes out, when the overall time on the machine reaches a certain amount, when a particular betting player reaches a set amount of time on the machine, total wins, total losses, and other similar information. The data reports can be generated by slot machine, by groups of machines such as types of machines, or certain settings of machines such as limits, or as an aggregate.

Advantageous, betting players can play in an even-odds, or close to even-odds, slot machine environment, thereby increasing their chances of winning as compared with a traditional slot machine. Additionally, banking players can play in an even-odds, or close to even-odds slot machine environment, and have the opportunity to play as the house without requiring a brick and mortar building.

### BRIEF DESCRIPTION OF THE DRAWINGS

FIG. 1 depicts an example of a system for providing a p2p slot machine game.

FIG. 2 depicts a flow chart of an example method for defining a slot machine as available for play.

FIG. 3 depicts a flow chart of an example method for defining a slot machine for play within a p2p slot machine environment.

FIG. 4 depicts a flow chart of an example method for capitalizing an account for play within a p2p slot machine environment.

FIG. 5 depicts a flow chart of an example method for operating a slot machine for play within a p2p slot machine environment.

FIG. 6 depicts a flow chart of an example method for managing a slot machine within a p2p slot machine environment.

FIG. 7 depicts a flow chart of an example method for auditing a slot machine within a p2p slot machine environment.

FIG. 8 depicts a flow chart of an example method for managing a failed slot machine audit within a p2p slot machine environment.

FIG. 9 depicts an example of a system for providing a p2p slot machine.

### DETAILED DESCRIPTION OF THE DISCLOSURE

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

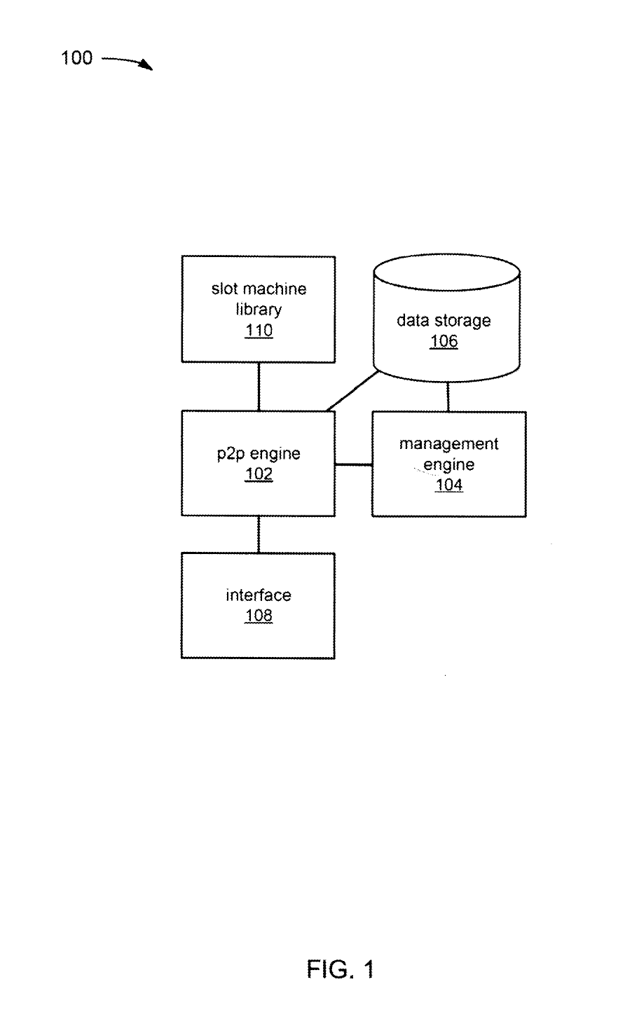

FIG. 1 depicts an example of a system 100 for providing a player-to-layer (“p2p”) slot machine. FIG. 1 includes a slot machine library 110, p2p engine 102, management engine 104, data storage 106, and interface 108.

In the example of FIG. 1, slot machine library 110 can be a programming library of functions useful to provide popular slot machine games. For example, slot machine library 110 can include a collection of functions for displaying different types of slot machine games, different slot machine themes, payout bonuses, types of bonuses, or otherwise providing slot machines for a user of a slot machine game. Such slot machine games can include progressive bonuses, classic slot machines with three or more reels, multi-reel games, and other slot machines that are known or convenient. New games may be added as they are created.

In the example of FIG. 1, p2p engine 102 can include a computer processor coupled to memory storing instructions for execution by the processor. The p2p engine 102 creates, operates, closes, and otherwise runs all slot machines within the p2p slot machine. These operations can generate a significant amount of data and the p2p engine 102 stores such data within data storage 106. Operation of p2p engine 102 includes debiting and crediting of user accounts for funds to capitalize a slot machine where associated financial data is stored in data storage 106.

In the example of FIG. 1, management engine 104 can include a computer processor coupled to memory storing instructions for execution by the processor. Management engine 104 can audit records created by p2p engine 102, and has the power to require p2p engine 102 to suspend a slot machine for financial, security, or other known or convenient reasons. For example management unit 104 can perform one or more of the methods included herein to monitor and audit slot machine activity.

In the example of FIG. 1 data storage 106 can be a data repository for storing information associated with a p2p slot machine. As used in this paper, a “repository” can be implemented, for example as software embodied in a physical computer-readable medium on a general-purpose or specific-purpose machine, in firmware, in hardware, in a combination thereof, or in any applicable known or convenient device or system.

The repositories described in this paper are intended, if applicable, to include any organization of data, including tables, comma-separated values (CSV) files, traditional databases (e.g., SQL), or other known or convenient organizational formats.

In an example of a system where a repository is implemented as a database, a database management system (DBMS) can be used to manage the repository. In such a case, the DBMS may be thought of as part of the repository or as part of a database server, or as a separate functional unit (not shown). A DBMS is typically implemented as an engine that controls organization, storage, management, and retrieval of data in a database. DBMS s frequently provide the ability to query, backup and replicate, enforce rules, provide security, do computation, perform change and access logging, and automate optimization. Examples of DBMSs include Oracle database, IBM DB2, FileMaker, Informix, Microsoft Access, Microsoft SQL Server, Microsoft Visual FoxPro, MySQL, and Openoffice.org Base, to name several. However, any known or convenient DBMS can be used.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

In the example of FIG. 1, interface 108 can be one or more of a graphical user interface for directly communicating with a user at a computing system operating the p2p slot machine, a data interface operable to service a user via a communication link to a separate computing device, or any known or convenient interface for communicating the operation of the p2p slot machine with a user. Such an interface can be useful for communicating over a network, such as the internet.

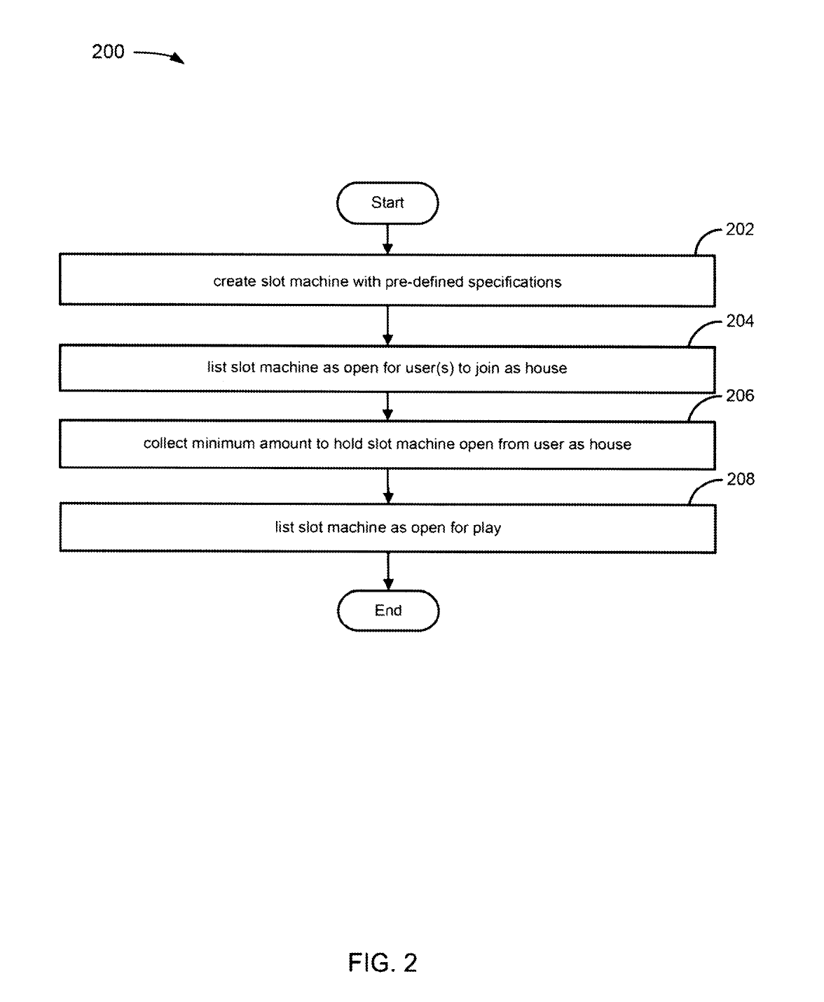

FIG. 2 depicts a flow chart 200 of an example method for defining a slot machine for play within a p2p slot machine. The method is organized as a sequence of modules in flowchart 200, however it should be understood that these and other modules associated with other methods described herein may be reordered for parallel execution or into different sequences of modules.

In the example of FIG. 2, the flowchart starts at module 202 with create slot machine with pre-defined specifications. In creating a slot machine, a library may be used to provide a slot machine of common use; for example a standard slot machine may include definitions for limits per spin, maximums odds-bets, minimum bet, and other known or convenient slot machine specifications. Similarly, standard slot machines may include similar values relevant to such slot games. There is some convenience in offering a slot machine with pre-defined specifications; a user may not wish to define all values for a slot machine and may instead use a predefined template of slot machine values.

In the example of FIG. 2, the flowchart continues to module 204 with list slot machine as open for user to join as house and become the banking player. In entering a slot machine as open for user to join as the banking player, the slot machine can be required to specify a player will be acting as the house to open the slot machine. Such requirements and availability of the slot machine can be saved to data storage. Once the slot machine is listed, users can view the slot machines, as well as other open slot machines, via an interface.

In the example of FIG. 2, the flowchart continues to module 206 with collect minimum amount to hold slot machine open for the banking player. One user can select to play as the banking player. Each banking player must have sufficient funds to play as the house; “sufficient funds” can vary from slot machine to slot machine and from type of slot machine to type of slot machine, but one exemplary method of determining sufficient funds is to identify the maximum payout that the slot machine could experience in a single round of betting, and require the banking player to maintain at least that amount to capitalize the slot machine. For slot machines that have a bonus payout, sufficient funds will be held from the banking player. Alternatively, a portion of such maximum loss, e.g., a margin, could be required of the banking player in order to open the slot machine.

In the example of FIG. 2. The flowchart continues to module 208 with list slot machines as open for play. This slot machine can then be entered into a data store as having met the requirements to allow betting players to play. Then when a betting player requests a list of available slot machines, the slot machine can be provided to the user that is a betting player as a part of that list. Having listed slot machines as open for play, the flowchart terminates.

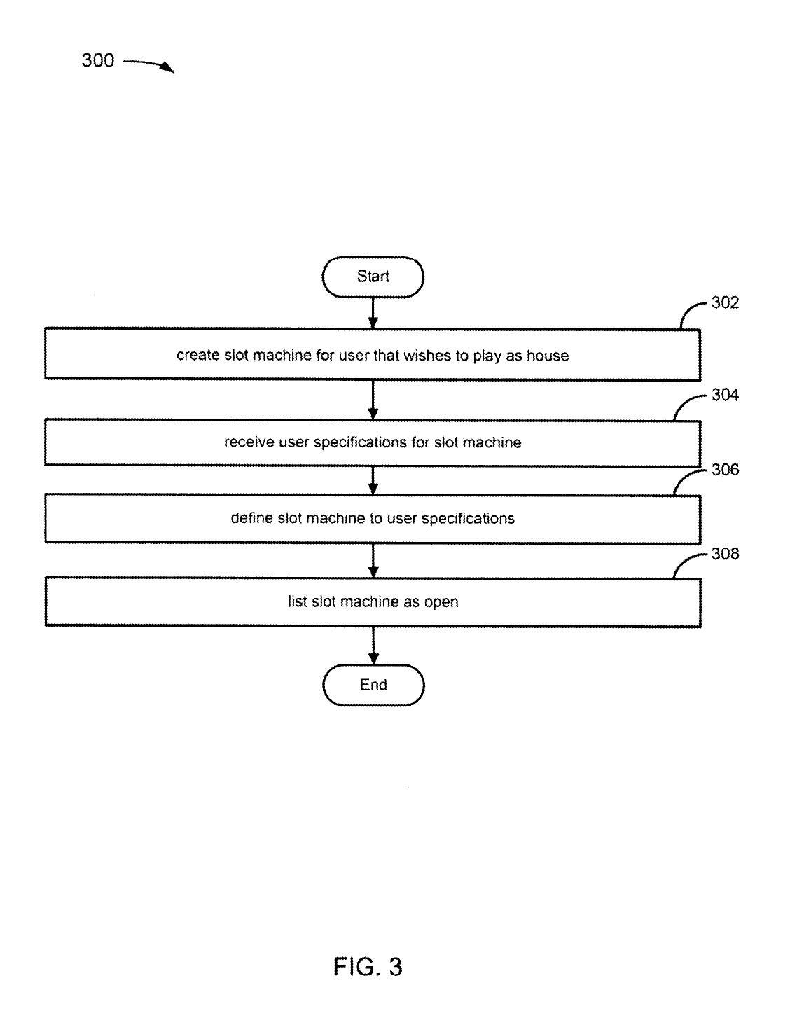

FIG. 3 depicts a flow chart 300 of an example method of defining a slot machine for play within a p2p slot machine. The method is organized as a sequence of modules in flowchart 300, however it should be understood that these and other modules associated with other methods described herein may be reordered for parallel execution or into different sequences of modules.

In the example of FIG. 3, the flowchart starts at module 302 with create slot machine for banking player that wishes to play as the house. Here a banking player can request a slot machine and set the parameters of the chosen slot machine. For example, the user may wish to limit the number of players to a certain sized slot machine, restrict players to his or her friends, set slot machine limits on betting amounts, or otherwise define the slot machine to desired specifications.

In the example of FIG. 3, the flowchart continues to module 304 with receive user specifications for slot machine. The banking player can transmit the specifications to the p2p slot machine via an interface and the specifications can be received and stored into a data store for the p2p slot machine. Such a transmission can be made by the internet, a local network, direct entry by the banking player into the computing system, or other known or convenient path.

In the example of FIG. 3, the flowchart continues to module 306 with define slot machine to user specifications. The slot machine specifications can be entered into a data store as defining a particular slot machine. Such specifications can be used by a p2p engine in conjunction with a game library to provide that slot machine. Additionally, a management engine can use the specifications in monitoring and editing the slot machine. The banking player may save their preferred slot machine settings into a data store to facilitate multiple slot machines or easy creation of the same type of slot machine.

In the example of FIG. 3 the flowchart continues to module 308 with list slot machine as open. Listing a slot machine as open can include making an entry in a data store that a particular slot machine is open for play. Once the slot machine has been listed as open, betting players can receive the slot machine in response to their requests for open slot machines. Having listed the slot machine as open, the flowchart terminates.

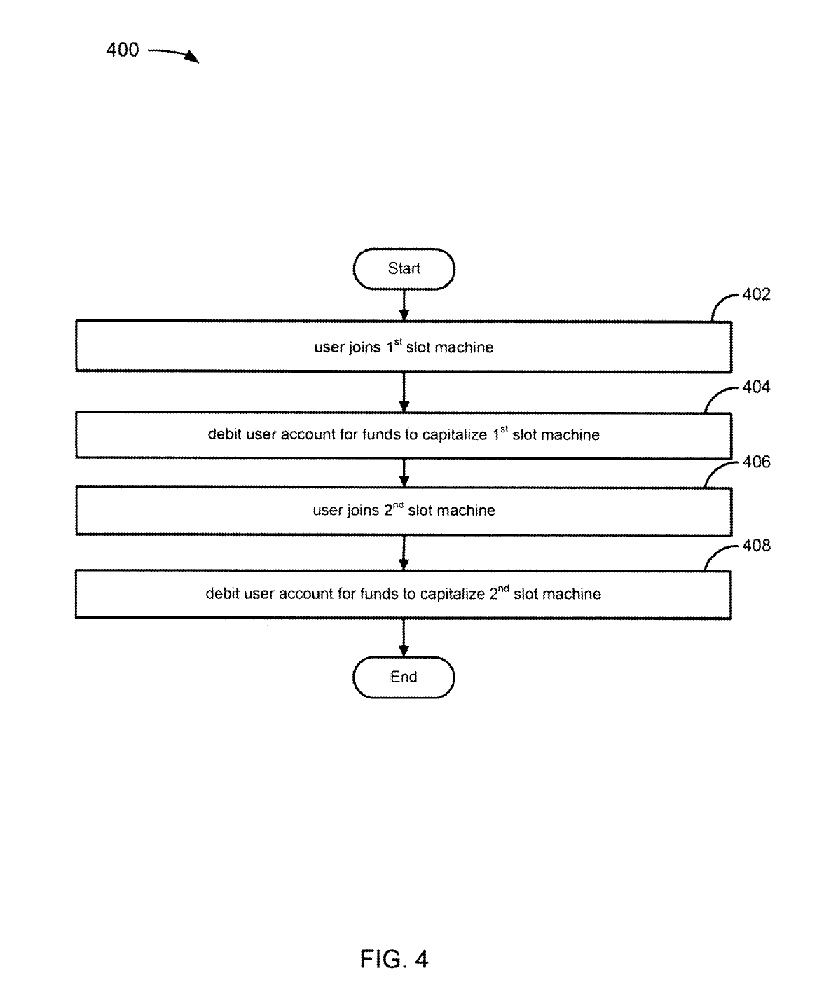

FIG. 4 depicts a flow chart 400 of an example method for capitalizing a slot machine for play within a p2p slot machine. The method is organized as a sequence of modules in flowchart 400, however it should be understood that these and other modules associated with other methods described herein may be reordered for parallel execution or into different sequences of modules.

In the example of FIG. 4, the flowchart starts at module 402 with a user acting as a betting player joining a first slot machine. When the betting player joins a slot machine, the act of joining can be reflected as an entry into a data store. This entry can associate the betting player with the identified slot machine such that a p2p engine treats the betting player as the betting player on the slot machine. Such data can be accessible to both the p2p engine and the management engine in operating and managing the slot machine.

In the example of FIG. 4, the flowchart continues to module 404 with debit user account for funds to capitalize the first slot machine. A slot machine can have a requirement for the amount of funds needed to play on that slot machine. A p2p engine can debit the required funds from an account associated with the betting player, or alternatively mark such funds as allocated to the first slot machine. Such allocation or debiting can ensure that the betting player will not fail to make payment to the banking player should he lose money while playing on the first slot machine. The amount of funds can be determined in part by determining the maximum loss on that slot machine by the betting player in a single round, or at least a portion of the maximum loss.

In the example of FIG. 4, the flowchart continues to module 406, with user joins second slot machine as betting player. Each user can be a betting player and/or banking player on more than one slot machine at the same time. In joining the second slot machine an entry can be made into a data store specifying that the user is not the betting player on the identified slot machine. When information about the slot machine is requested, the user will be identified as playing on that particular slot machine.

In the example of FIG. 4, the flowchart continues to module 408 with debit user account for funds to capitalize the second slot machine. The betting player's ability to pay for any losses can be ensured when the user joins the slot machine, and may be recalculated each betting round, or after some other predetermined period of time, or after losing a certain amount of money. This can be accomplished by specifying an amount of funds to mark, escrow, set aside, or otherwise make available solely for payment of losses to the second slot machine. Having debited the betting players account for funds to capitalize the second slot machine, the flowchart terminates.

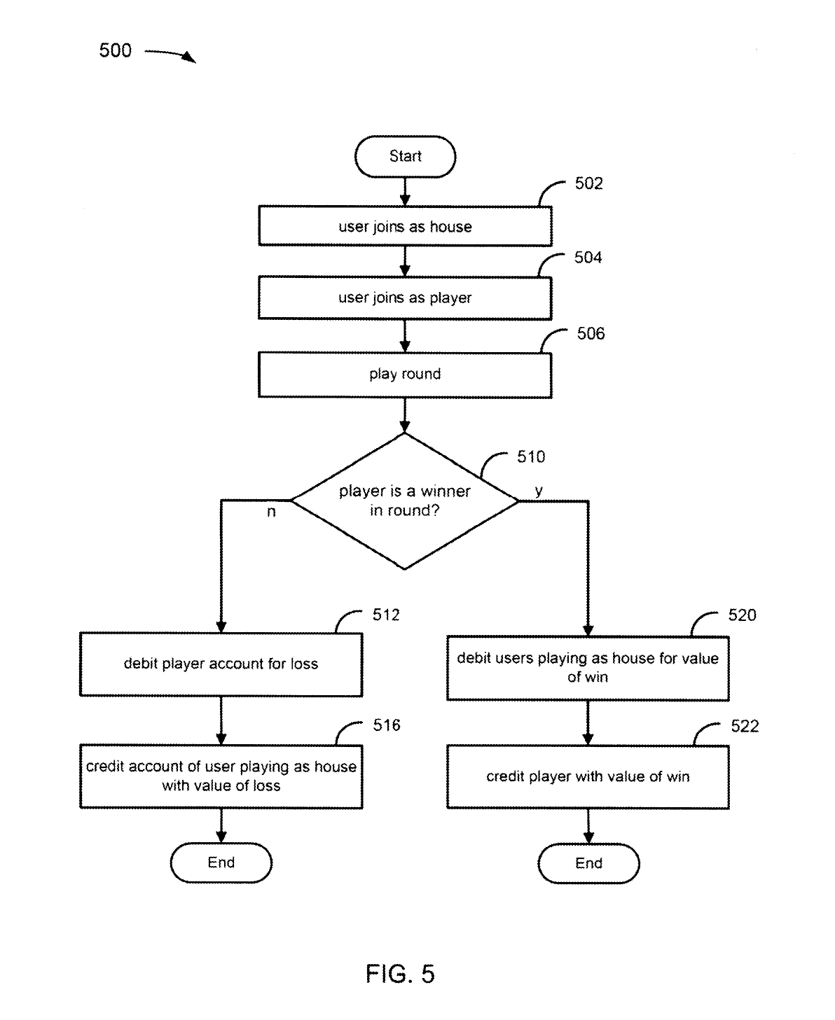

FIG. 5 depicts a flow chart 500 of an example method of operating a slot machine for play within a p2p slot machine environment. The method is organized as a sequence of modules in flowchart 500, however it should be understood that these and other modules associated with other methods described herein may be reordered for parallel execution or into different sequences of modules.

In the example of FIG. 5, the flowchart starts at module 502 with user joins as house and acts as the banking player. The user can required to have sufficient funds to cover losses by the house, and can place those funds into an account associated with the slot machine.

In the example of FIG. 5 the flowchart continues to module 504 with a second user joins and acts as the betting player. The betting player provides a minimum of the amount required to play a round on the slot machine. Such an amount can vary from game to game.

In the example of FIG. 5 the flowchart continues to module 506 with play round. The slot machine plays a round of a current game, with betting players playing against banking players according to the rules of the particular slot machine game.

In the example of FIG. 5, the flowchart continues to decision module 510 with determining whether the betting player is a winner in the round. The betting player is determined to be a winner or a loser in accordance with the rules of the game. The payout is also determined in accordance with the rules of the game. If the decision at 510 is no, and the betting player loses, the flowchart proceeds to module 512. If the decision at 510 is yes and the betting player wins, then the flowchart proceeds to module 520.

In the example of FIG. 5 if the decision at module 510 is no, the flowchart continues from decision module 510 to module 512 which debits the betting players account for the loss. The amount of the loss is determined in accordance with the rules for the game being played.

In the example of FIG. 5, the flowchart continues to module 516 which credits the banking player's account with the value of the loss. In one implementation, multiple players may bank a single slot machine, and the loss is distributed to those players. Having credited accounts of the banking player, the flowchart terminates.

In the example of FIG. 5, if the decision at module 510 is yes, and the betting player wins, the flowchart continues to module 520 with debit banking players account for the value of the win. The amount required form the banking player is collected from their respective account.

In the example of FIG. 5, the flowchart continues to module 522 with credit player with value of win. Here the amount collected in the previous module can be delivered to the winning player. Having credited the betting player with the value of the win, the flowchart terminates.

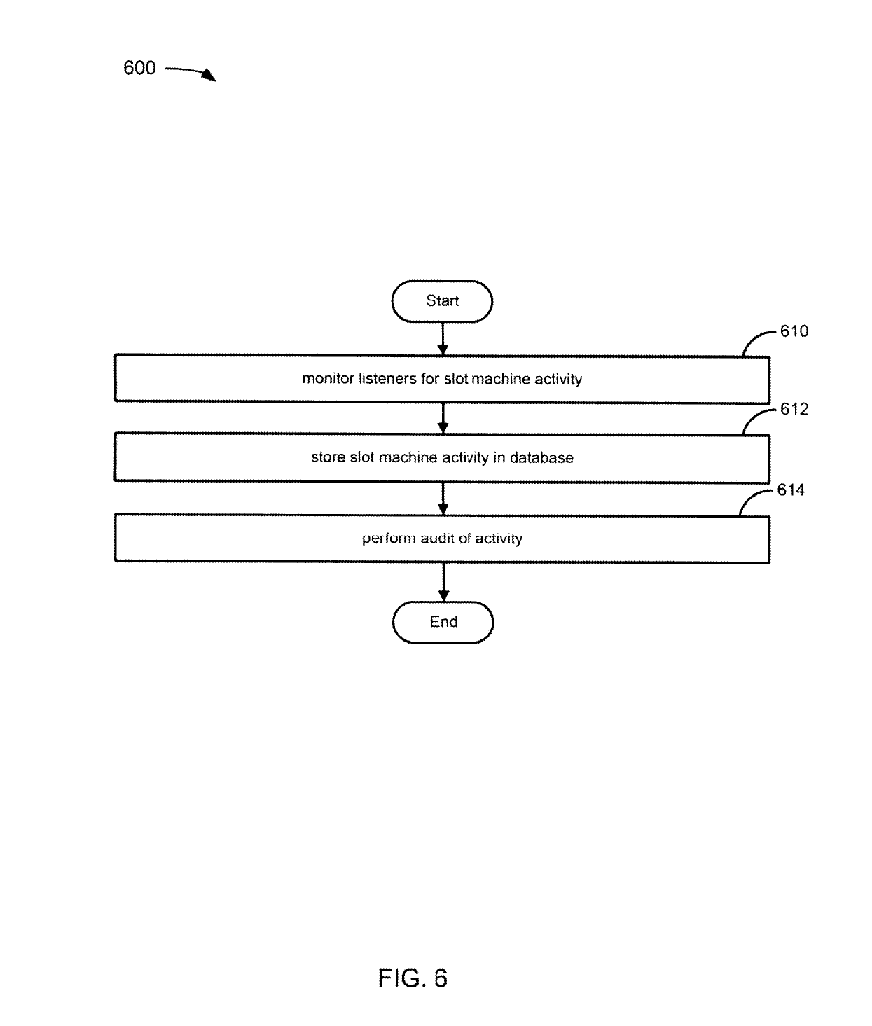

FIG. 6 depicts a flow chart 600 of an example of a method for managing a slot machine within a p2p slot machine environment. The method is organized as a sequence of modules in flowchart 600, however it should be understood that these and other modules associated with other methods described herein may be reordered for parallel execution or into different sequences of modules.

In the example of FIG. 6, the flowchart starts at module 610 with monitor listeners for slot machine activity. Software in memory, executing on a processor, can be used to provide the slot machine with a listener or function that collects slot machine data. A management engine can collect the slot machine activity or slot machine data from the listener. The information can be useful for analysis of the activities of the slot machine, such as for auditing and security purposes. Additionally the data stored may be used to provide triggers and data alerts to banking players. The management system may provide numerous alerts and information to a banking player. For example, alerts may be sent when the banking player has won or lost a certain amount of money, when the betting player has hit a jackpot or other certain amount, when a certain amount of aggregate handle has been played, when any betting player deposits money into the machine, when a betting player leaves the machine, when a particular betting player deposits money into the slot machine, when a particular betting player has reached a set amount of time, handle, wins, losses, and/or other threshold, and other similar information.

In one embodiment, the p2p slot machine has a plurality of settings that enable the machine to be enabled, disabled, suspended, or otherwise altered based on triggers associated with play. Triggers include, without limitation, when the banking player wins or loses a certain amount of money, when the betting player has hit a jackpot or other certain amount, when the banking player's account reaches a set amount of money, when a certain amount of aggregate handle has been played, when any betting player deposits money into the machine, when a betting player leaves the machine, when a particular betting player deposits money into the slot machine, when a particular betting player has reached a set amount of time, handle, wins, losses, and/or other threshold, and other similar information, when a betting player deposits money, when a betting player redeposit money, when a betting player cashes out, when the overall time on the machine reaches a certain amount, when a particular betting player reaches a set amount of time on the machine, total wins, total losses, and other similar information.

In one embodiment, the management system generates data reports based on play on the slot machine. The data reports may contain results and payouts tracked during play and may be related to certain points in a video recording of play so that the banking player can see when certain triggering events occurred. The triggering events include, without limitation, when the banking player wins or loses a certain amount of money, when the betting player has hit a jackpot or other certain amount, when the banking player's account reaches a set amount of money, when a certain amount of aggregate handle has been played, when any betting player deposits money into the machine, when a betting player leaves the machine, when a particular betting player deposits money into the slot machine, when a particular betting player has reached a set amount of time, handle, wins, losses, and/or other threshold, and other similar information, when a betting player deposits money, when a betting player redeposit money, when a betting player cashes out, when the overall time on the machine reaches a certain amount, when a particular betting player reaches a set amount of time on the machine, total wins, total losses, and other similar information. The data reports can be generated per machine or as a group of machines with a variety of different queries and settings that can be determined by the admin to generate certain types of reports.

In the example of FIG. 6, the flowchart continues to module 612 with store slot machine activity in database. The data received form the listener can be stored in a data storage repository, e.g., a database such as any discussed herein. The data can be organized by slot machine, by type of machine, by player identifier, by betting player, by banking player, or any other known or convenient schema.

In the example of FIG. 6. The flowchart continues to module 614 with perform an audit of activity. The audit of the data collected from the listener can be analyzed, e.g., by a management engine for irregularities, insufficient funds, security breaches, user requirements, or any known or convenient audit factor. Having performed an audit of activity, the flowchart terminates.

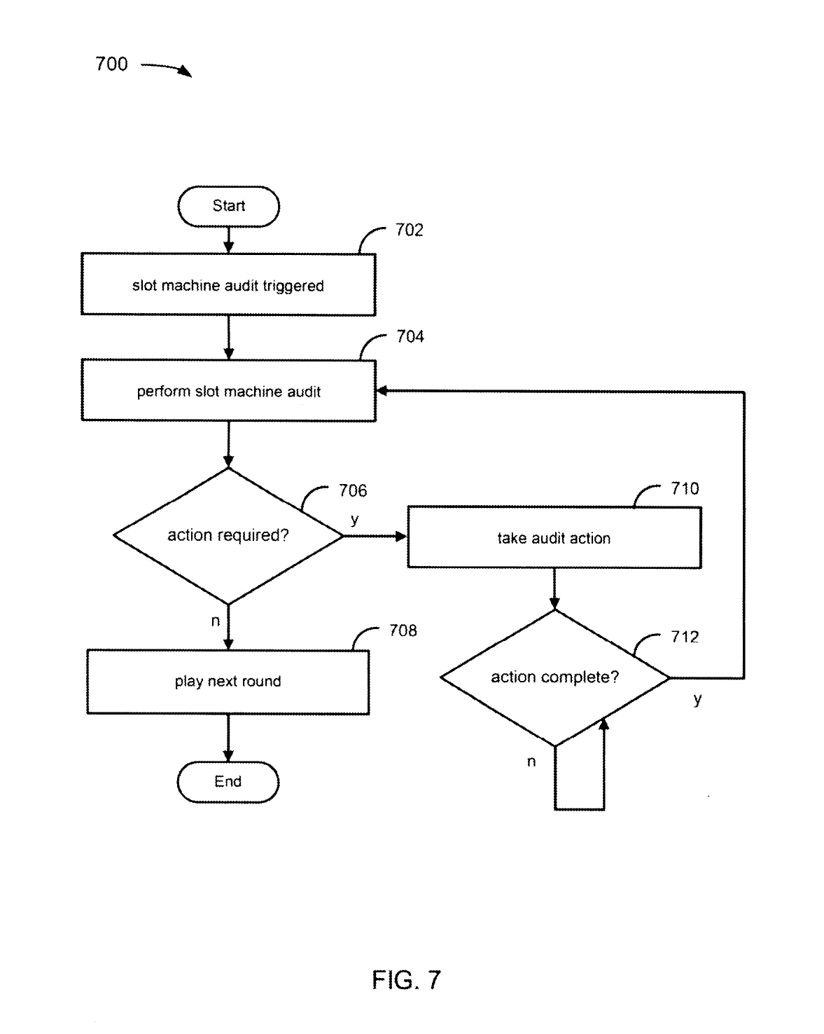

FIG. 7 depicts a flow chart 700 of an example method for auditing a slot machine within a p2p slot machine environment. The method is organized as a sequence of modules in flowchart 700, however it should be understood that these and other modules associated with other methods described herein may be reordered for parallel execution or into different sequences of modules.

In the example of FIG. 7, the flowchart starts at module 702 with slot machine audit triggered. A slot machine audit can be triggered at the end of every round, where a security violation is detected, or where any known or convenient need for an audit is raised.

In the example of FIG. 7 the flowchart continues to module 704 with perform slot machine audit. In performing the slot machine audit, the auditing process can perform one or more tests required for the audit, including checking that sufficient funds are available for each betting player on the slot machine, that any data checksums or has values are accurate, the all user computing systems are responding to requests, or any other known or convenient test.

In the example of FIG. 7, the flowchart continues to decision module 706 with determining whether action is required. The decision can be yes where action is required and the decision can be no where action is not required. Action can be required by any rule controlling the slot machine, e.g. a requirement of the game being played, insufficient funds, security violation, or other known or convenient requirement. For example, action can be required by the loss of player funds below a level at which the player could pay should he lose another round. If the decision at 706 is no, the flowchart proceeds to module 708. If the decision at 706 is yes, then the flowchart proceeds to module 710.

In the example of FIG. 7, if the decision at module 706 is no, the flowchart continues to module 708 with play the next round. Assuming the audit has completed successfully, the next round is played. Having played the next round, the flowchart terminates.

In the example of FIG. 7, if the decision at 706 is yes, the flowchart continues from decision module 706 to module 710 with take audit action. An individual audit action can be an action designed to remedy a particular issue, e.g., where there are insufficient funds, the betting player can be required to add funds. Where there are not enough players to play the game, the game play can be halted while new players are identified. Any other audit action can be identified and applied as needed.

In the example of FIG. 7, the flowchart continues to decision module 712 with determining whether the action is complete. An action can require time to complete or may involve multiple steps. Where the slot machine has not completed the current action, or where a subsequent step is required in an action, the flowchart remains at module 712. The module evaluates and re-evaluates until such time as the audit action has been completed. The decision can be yes where the audit action has completed, and no when the audit action has not completed.

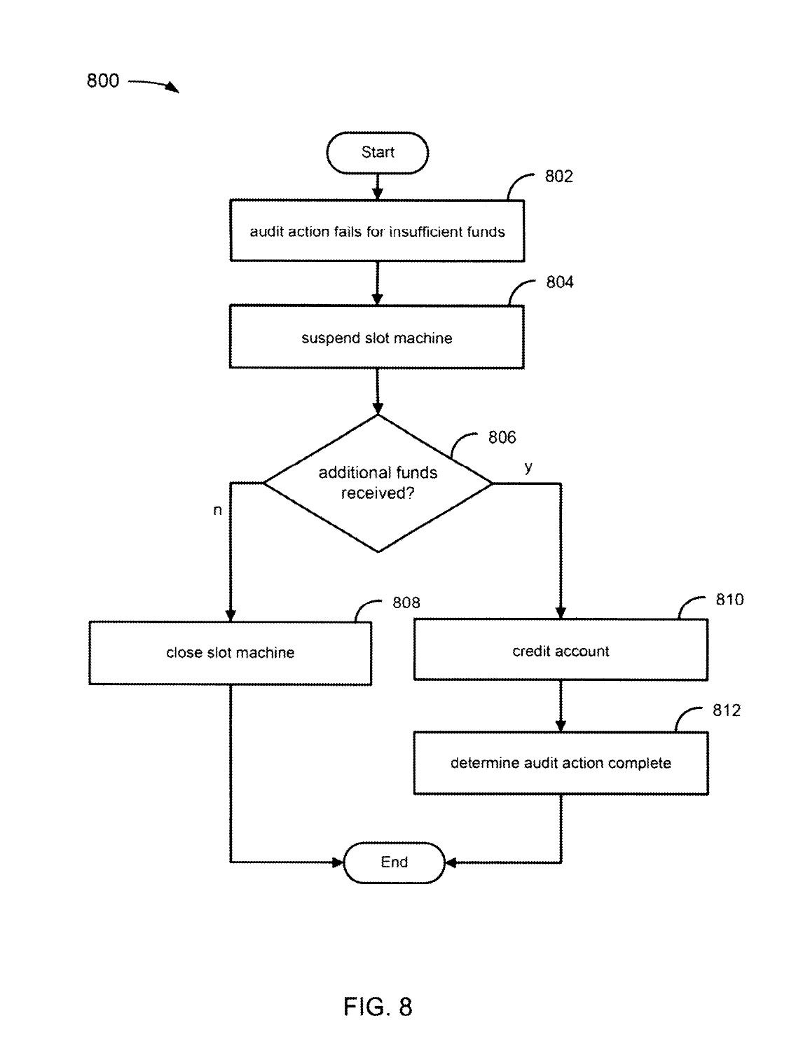

FIG. 8 depicts a flow chart 800 of an example method of managing a failed slot machine audit within a p2p slot machine environment. The method is organized as a sequence of modules in flowchart 800, however it should be understood that these and other modules associated with other methods described herein may be reordered for parallel execution or into different sequences of modules.

In the example of FIG. 8, the flowchart starts at module 802 with audit action fails for insufficient funds. A banking player can be audited to determine whether the banking player has sufficient funds to cover potential losses for all potential outcomes in the slot machine. A betting player can be audited to determine whether the user has sufficient funds to make and cover the cost to play a round. A common audit failure will occur where one of the players has run out of money. This is particularly important where the banking player has insufficient funds because the slot machine depends on the banking player to satisfy wins of players. Where one of the players has insufficient funds, and where no margin, loan, or other system has been put into place to prevent a player from running out of funds, the audit action for sufficient funds can fail. In at least one embodiment, banking player and/or the betting player may automatically transfer additional funds into their respective accounts if the audit fails.

In the example of FIG. 8 the flowchart continues to module 804 with suspend slot machine. If a betting player has insufficient funds, he cannot be allowed to continue playing until funds have been added to the account. If a banking player has insufficient funds, the slot machine must be suspended until funds have been added to the account. Once funds have been added to the account, play may be resumed. Players can have a master account and one or more slot machine accounts. Where only the slot machine account is exhausted, players can supply funds the slot machine account from the master account. The master account may be supplied from outside sources, such as cash, credit cards, bank transfers, etc. The slot machine is typically allowed to continue play with other users while the betting player adds funds to the account. In one embodiment, a period of time is allowed to the current betting player to add funds before a new betting player is found.

In the example of FIG. 8, the flowchart continues to decision module 806 with determining whether additional funds have been received. After a brief delay, a check can be performed to determine whether the user has added funds. Alternatively, the system can alert the management engine that the funds have been received and the decision module can be evaluated. The decision can be no where the funds have not been added and the decision is yes where the funds have been added. If no funds were added the flowchart proceeds to module 808 and the machine is closed. In closing the slot machine, user accounts can be reconciled, and the users are disassociated from the slot machine. Having closed the slot machine, the flowchart terminates.

In the example of FIG. 8 if the decision at 806 is yes and funds have been added the flowchart proceeds to module 810. Once the additional funds have been received, the funds can be stored into an account associated with the slot machine.

In the example of FIG. 8, the flowchart continues to module 812 which determines whether the audit action is complete. This entry can notify the management engine that the particular audit event associated with insufficient funds has been completed. If there are any other audit events unrelated to funding, they may need to be resolved before returning to play. Having determined that the audit action is complete, the flowchart terminates.

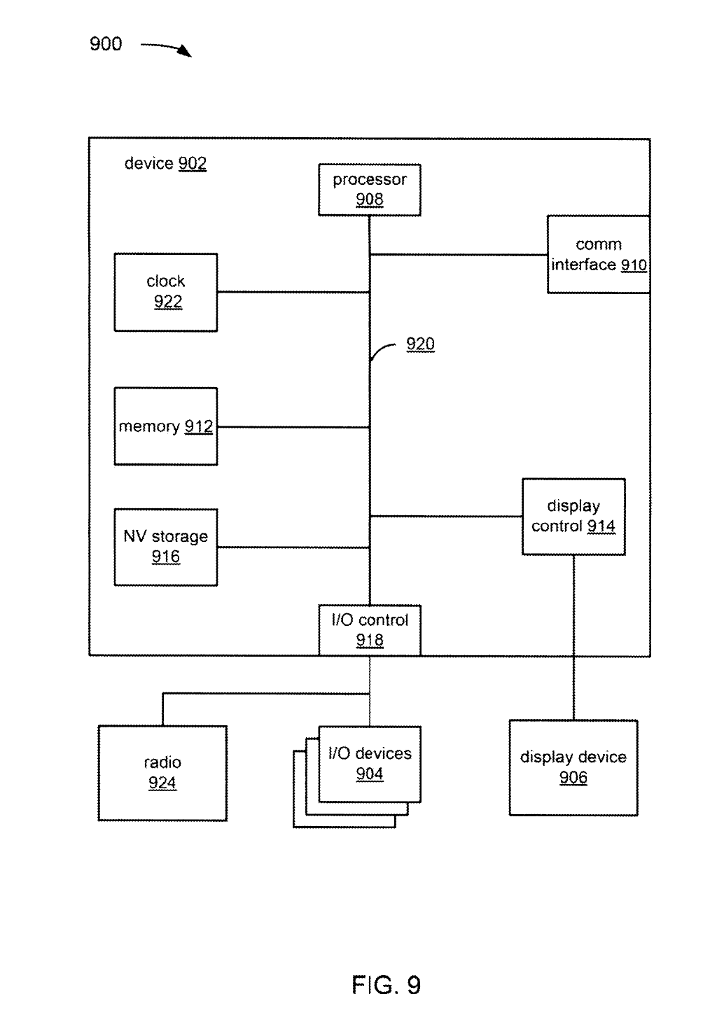

FIG. 9 depicts an example of a system for providing a player-to-player slot machine. The system 900 may be a conventional computer system that can be used as a client computer system, such as wireless client or a workstation, or a server computer system. The system 900 includes a device 902, I/O devices 904, and a display device 906. The device 902 includes a processor 908, a communications interface 910, memory 912, displayer controller 914, non-volatile storage 916, I/O controller 918, clock 922, and radio 924. The device 902 may be coupled to or include the I/O devices 904 and the display device 906.

The device 902 interfaces to external systems through the communications interface 910, which may include a modem or network interface. It will be appreciated that the communications interface 910 can be considered to be part of the system 900 or a part of the device 902. The communications interface 910 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMA/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems.

The processor 908 may be, for example, a conventional microprocessor such as an Intel Pentium microprocessor or Motorola power PC microprocessor. The memory 912 is coupled to the processor 908 by a bus 920. The memory 912 can be Dynamic Random Access Memory (DRAM) and can also include Static RAM (SRAM). The bus 920 couples the processor 908 to the memory 912, also to the non-volatile storage 916, to the display controller 914, and to the I/O controller 918.

The I/O devices 904 can include a keyboard, disk drives, printers, a scanner, and other input and output devices, including a mouse or other pointing device. The display controller 914 may control in the conventional manner a display on the display device 906, which can be, for example, a cathode ray tube (CRT) or liquid crystal display (LCD). The display controller 914 and the I/O controller 918 can be implemented with conventional well known technology.

The non-volatile storage 916 is often a magnetic hard disk, flash memory, an optical disk, or another form of storage for large amounts of data. Some of this data is often written, by a direct memory access process, into memory 912 during execution of software in the device 912. One of skill in the art will immediately recognize that the terms “machine-readable medium” or “computer-readable medium” includes any type of storage device that is accessible by the processor 908.

Clock 922 can be any kind of oscillating circuit creating an electrical signal with a precise frequency. In a non-limiting example, clock 922 could be a crystal oscillator using the mechanical resonance of vibrating crystal to generate the electrical signal.

The radio 924 can include any combination of electronic components, for example transistors, resistors, and capacitors. The radio is operable to transmit and/or receive signals.

The system 900 is one example of many possible computer systems which have different architectures. For example, personal computers based on an Intel microprocessor often have multiple buses, one of which can be an I/O bus for the peripherals and one that directly connects the processor 908 and the memory 912 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 912 for execution by the processor 908. A typical computer system will usually include at least a processor, memory, and a bus coupling the memory to the processor.

In addition, the system 900 is controlled by operation system software which includes a file management system, such as a disk operating system, which is part of the operating system software. One example of operating system software with its associated file management system software is the family of operating systems known as Windows® from Microsoft Corporation of Redmond, Wash., and their associated file management system software is the Linux operating system and its associated file management system. The file management system is typically stored in the non-volatile storage 916 and causes the processor 908 to execute the various acts required by the operating system to input and output data and to store data in memory, including storing files on the non-volatile storage 916.

Some portions of the detailed description are presented in terms of algorithms and symbolic representations of operations on data bits within a computer memory. These algorithmic descriptions and representations are the means used by those skilled in the data of processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the link, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMS, and magnetic-optical disks, or any type of media suitable for storing electronic instructions, and each couple to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

What is claimed is:

1. A system for generating a peer-to-peer (p2p) slot machine comprising:
a peer-to-peer (p2p) engine, wherein the p2p engine is configured to create a slot machine for play between a first user acting as a banking player and a second user acting as a betting player;
an interface coupled to the p2p engine and configured to receive data from the banking player and the betting player; and
a management engine coupled to the p2p engine, wherein the management engine is configured to audit the slot machine.

2. The system of claim 1, wherein the management engine is further configured to collect slot machine activity data.

3. The system of claim 2, wherein the management engine is further configured to identify at least one trigger based on the slot machine activity data and send an alert to the banking player based on the trigger.

4. The system of claim 3, wherein the trigger is at least one of the banking player winning more than a first predetermined threshold amount of money, the banking player losing more than a second predetermined threshold amount of money, the betting player hitting a jackpot, an aggregate handle exceeding a handle threshold, the betting player depositing additional money into the machine, the betting player leaving the machine, and a particular betting player depositing money into the slot machine.

5. The system of claim 3, wherein the management engine is further configured to receive instructions from the betting player to automatically place a particular bet until a trigger is detected.

6. The system of claim 2, wherein the management engine is further configured to record segments of play on the slot machine based on the slot machine activity data.

7. The system of claim 2, wherein the management engine is further configured to transmit a data report to at least one of the betting player and the banking player based on the slot machine activity data.

8. The system of claim 6, wherein the data report is based on slot machine activity data gathered from at least one of all slot machines associated with the betting player, all slot machines associated with the banking player, types of slot machines associated with the banking player, and types of slot machines associated with the betting player.

9. The system of claim 1, wherein the management engine is further configured to determine an amount of funds in a banking player account; and
suspend the slot machine if the amount of funds in the banking player account is less than a predetermined threshold.

10. The system of claim 1, wherein the management engine is further configured to determine an amount of funds in a betting player account; and
suspend the betting player from play on the slot machine if the amount of funds in the betting player account is less than a predetermined threshold.

11. The system of claim 1 wherein the p2p engine is further configured to receive user specifications for the slot machine from the banking player, the user specification defining at least one characteristic of the slot machine.

12. The system of claim 7, wherein the characteristic is at least one of, a minimum bet, a maximum bet, progressive jackpot settings, limits per spin, and public/private settings.

13. The system of claim 1, wherein the p2p engine is further configured to generate a plurality of slot machines for play between the banking player and a plurality of betting players.

14. The system of claim 1, wherein the p2p engine is further configured to generate a slot machine for play between a plurality of banking players and the betting player, wherein the plurality of banking players share a payout of the slot machine.

15. A method of generating a p2p slot machine, said method implemented with a processor coupled to a memory, said method including creating, with a p2p engine, a slot machine for play between a first user acting as a banking player and a second user acting as a betting player;
receiving data from the banking player and the betting player through an interface; and
auditing, by a management engine, the slot machine.

16. The method of claim 15 further comprising collecting slot machine activity data.

17. The method of claim 16 further comprising identifying at least one trigger based on the slot machine activity data and sending an alert to the banking player based on identifying the trigger.

18. The method of claim 16 further comprising identifying at least one trigger based on the slot machine activity data and recording segments of play on the slot machine based on identifying the trigger.

19. The method of claim 15 further comprising determining an amount of funds in a banking player account; and
suspending the slot machine if the amount of funds is less than a predetermined threshold.

20. A computer readable medium having computer-executable instructions for generating a p2p slot machine, wherein, when executed by a processor, the computer-executable instructions cause the processor to:
create a slot machine for play between a first user acting as a banking player and a second user acting as a betting player;
receive data from the banking player and the betting player through an interface; and
audit the slot machine.
